(19) United States
(12) Patent Application Publication
(10) Pub. No.: US 2005/0168824 A1
(43) Pub. Date: Aug. 4, 2005

(54) Binocular virtual display imaging device

(75) Inventors: Paul Travers, Honeoye Falls, NY (US); David Vogler, Rochester, NY (US); James D. Gresko, Rochester, NY (US); Stephen Glaser, Pittsford, NY (US); Paul J. Churnetski, West Henrietta, NY (US); Scott Leathersich, Henrietta, NY (US)

Correspondence Address: Stephen B. Salai, Esq.;Harter, Secrest & Emery LLP, 1600 Bausch & Lomb Place, Rochester, NY, 14604-2711, US

(73) Assignee: Interactive Imaging Systems, Inc., Rochester, NY (US)

(21) Appl. No.: 10/999,424

(22) Filed: Nov. 30, 2004

Related U.S. Application Data
(63) Continuation-in-part of application No. 10/752,746, filed on Jan. 7, 2004.

(51) Int. Cl. G02B 27/14

(52) U.S. Cl. 359/630

(57) ABSTRACT

An imaging device for operably disposing a virtual display in front of each eye of a user and an optional speaker attachable to the imaging device. The imaging device of the present invention includes a binocular frame for securing the imaging device to the user including two adjustable bows such that the virtual display of the imaging device is adjustable and pivotable to at least viewing positions with respect to the line of sight of the user.

### BACKGROUND OF THE INVENTION

1. Field of the Invention

The present invention relates to a binocular virtual display imaging device, and more particularly, to an imaging device supporting a virtual display in front of both eyes wherein the imaging device is sufficiently coupled to the head to be easily adjustable to at least two viewing positions and to optionally include an audio device.

2. Description of Related Art

Virtual displays have continued to improve and get smaller which has resulted in a need for better and more comfortable virtual display headpieces. Alternative display supports have employed a helmet which includes a mounted visor but these generate discomfort if worn for extended periods of time and also are difficult to stabilize and thus they make it difficult for the user to keep the virtual display at the correct location for optimum viewing.

Therefore, the need exists for a lightweight BINOCULAR VIRTUAL DISPLAY IMAGING DEVICE to allow a user to optimize the virtual display being viewed while being able to view other items in a non-immersive environment as well as being relatively simple to adjust and stabilize.

### BRIEF SUMMARY OF THE INVENTION

The imaging device of the present invention includes a binocular frame for securing the imaging device to the user including two adjustable bows such that the virtual display of the imaging device is adjustable and pivotable to at least two viewing positions with respect to the line of sight of the user.

### BRIEF DESCRIPTION OF THE SEVERAL VIEWS OF THE DRAWING(S)

FIG. 1 is a perspective view of a IMAGING DEVICE.

FIG. 2 is a front view of the IMAGE DEVICE.

FIG. 3 a-c is a side view of the IMAGING DEVICE.

FIG. 4 is a front view of the front frame on the nose of a viewer.

FIG. 5 a-c is another side view of the IMAGING DEVICE in the second position.

FIG. 6 is a view of the IMAGING DEVICE with earpiece.

FIG. 7 is a top view of the IMAGING DEVICE.

FIG. 8 is a view of the earpiece with a speaker.

FIG. 9 is a perspective view of an imaging device in accordance with a presently preferred embodiment of the invention showing removable nose pieces and a mechanical and electrical connection for earbuds.

FIG. 10 is a top front left side perspective of embodiment of the invention in accordance with FIG. 9 with right and left earbuds in place.

FIG. 11 is an exploded view of an earbud in accordance with this invention.

### DETAILED DESCRIPTION OF THE INVENTION

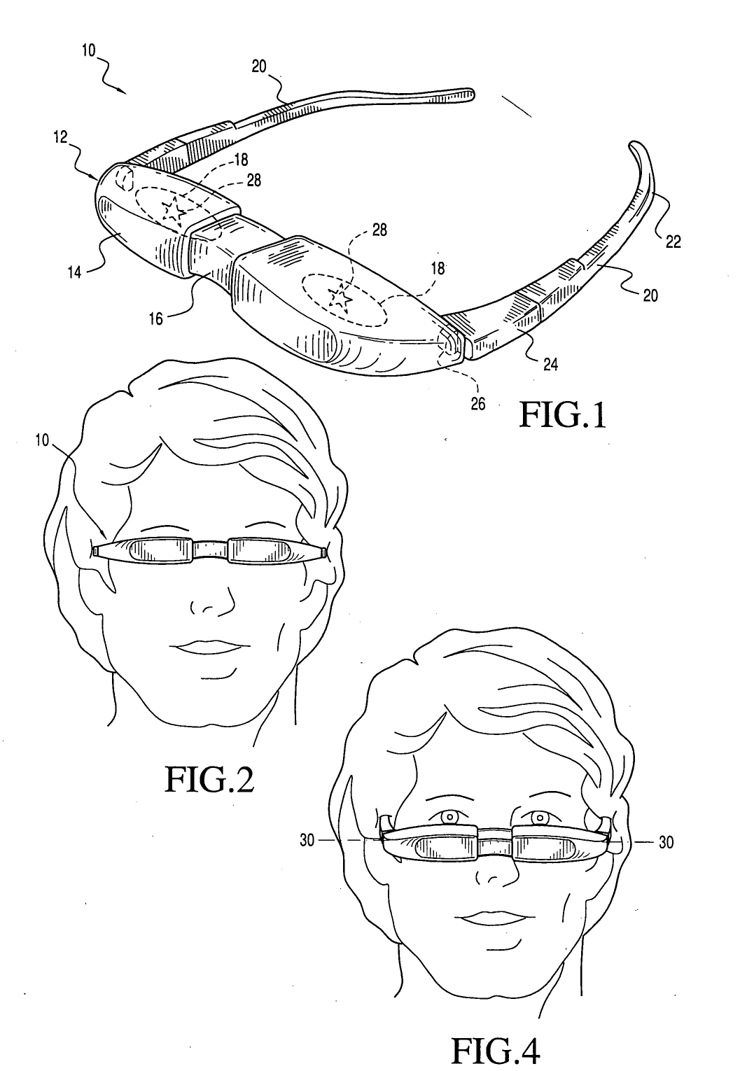

FIGS. 1 and 2 show a virtual display imaging device 10. The imaging device includes a binocular frame 12, including a front frame 14 and a nose piece 16 for supporting a virtual display in front of each eye preferably a micro display such as the one described in the co-pending application MICRO DISPLAY ENGINE owned by the same assignee. The frame could alternatively support one virtual display engine with a means to project an image to each eye through electronic or optical means. The binocular frame 12 attaches to a pair of bows 20. Each bow 20 has a back piece 22, a front piece 24, and a pivotal connector 26.

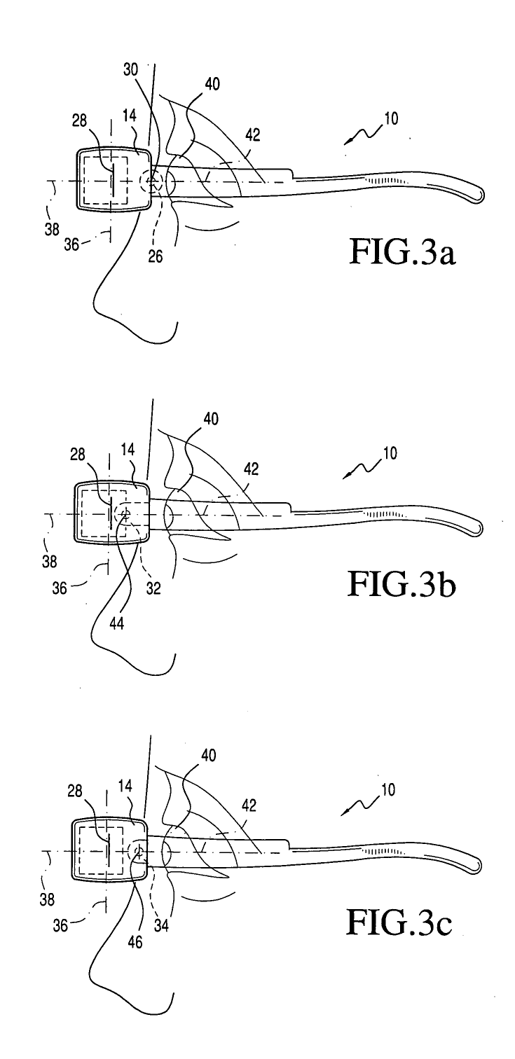

As shown in FIG. 1, this binocular imaging device-type-viewing device is not designed to be totally immersive. Although both eyes can view the virtual displays 18, it is possible to adjust the virtual display 28 above or below the viewer's eyes so that the user can continue to monitor the environment. The user can further monitor the environment or even primarily monitor the environment while still viewing the display by the angular adjustment feature that allows the displays to be moved out of a first line of sight and be tilted into a second line of sight as shown in FIGS. 3 and 4.

FIG. 3a shows a side view of the virtual display imaging device 10 including the pivotable connector 26 which has a pivotal axis 30 (see FIG. 4) between the bows and the front frame of the binocular display assembly. The optical assembly 30 of the virtual display is located in the front frame 14. In other embodiments the pivotal connection 32 could be located alternatively in this optical display 30 as shown in FIG. 3b or the pivotal connection 34 may be in the front frame 14 but not in the optical assembly as shown in FIG. 3a. FIG. 3 shows the display image plane 36 and a line normal to the display viewing plane 38, represented by line 38. The present invention allows the eye of the user to maintain an image in a line of sight 42 that is coincident with line 38 and thus normal to the display image plane 36. This keeps the image from being clipped and reduces eye strain.

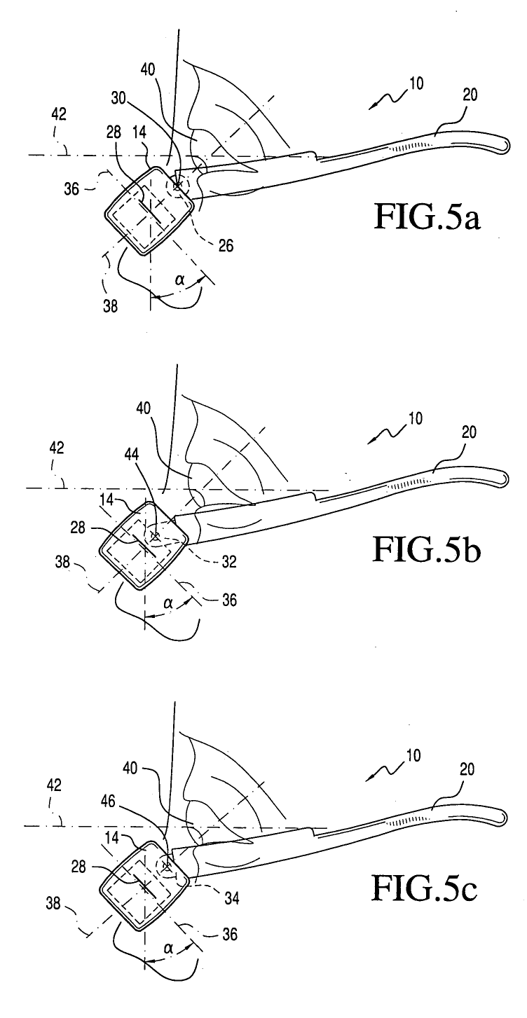

FIGS. 5a-c show a side view of the front frame 14 at an angled position as it is pivoted around axis 30 such that the optical assembly 18 is now at an angle to the bow 20 as would happen if the display was moved down the nose of a user and the user was looking down through the optical display similar to the use of reading glasses. Now the display image plane 36 has moved through an angle α putting the user's view of sight nominally normal to the display image plane 36. This feature allows the user to angularly adjust the display as it is slid down a user's nose about an axis 28 that allows the user to continue viewing the display(s) on center as shown in FIGS. 4 and 5. In other words, the display image planes as projected from the two imaging devices are pivoted so that they remain within the user's line of sight, for example, nominally normal to the new viewing direction, even though the displays have been initially moved out of the originally intended line of site. This allows viewing in both an immersive and non-immersive environment. The addition of eye caps or a shroud would allow a user the chance to be in an entirely immersive environment. Thus, this allows for a relaxed immersive and non-immersive experience to not clip image or strain eyes. Alternatively, the optical assembly can be pivoted about axis 44 (FIG. 5b) or the front frame about axis 46 (FIG. 5c).

There may be other related modifications that will enhance the viewer's ease of adjustment and comfort. They include other pivotable positions and points beyond the bow pivots for carrying out this invention. For example, changes in the bridge or in the bows themselves beyond their interconnection with the front frame could be made by additional adjustments at their joints. Alternatively, it may be possible to articulate the bows to pivot the displays within the front frame to obtain a similar result.

FIG. 6 shows an earpiece 30 attached to the bow 20 of the imaging device 10. The earpiece 30 allows an audio addition by combining an earpiece 30, such as the boom-mounted earpiece 30, shown on the binocular imaging device. The addition of a boom 32, suspended speaker 34 for the binocular virtual display imaging device 10 allows the user to receive audio signals. Since the binocular imaging device 10 is of the type that fits on the head, similar to eyeglasses, it is very comfortable. The frame supports a separate display for each eye. The frame 12 can be made with permanent speakers in at least one of the bows but this requires that the speaker(s) is chosen in advance or built in. The embodiment shown in FIG. 6 allows the end user to choose a speaker with the audio content desired. Since at least one of the bows 20 includes an ear phone jack receptacle 36 for communicating audio output. The earpiece 30 or earphone can be plugged into the jack 36 for producing audio output.

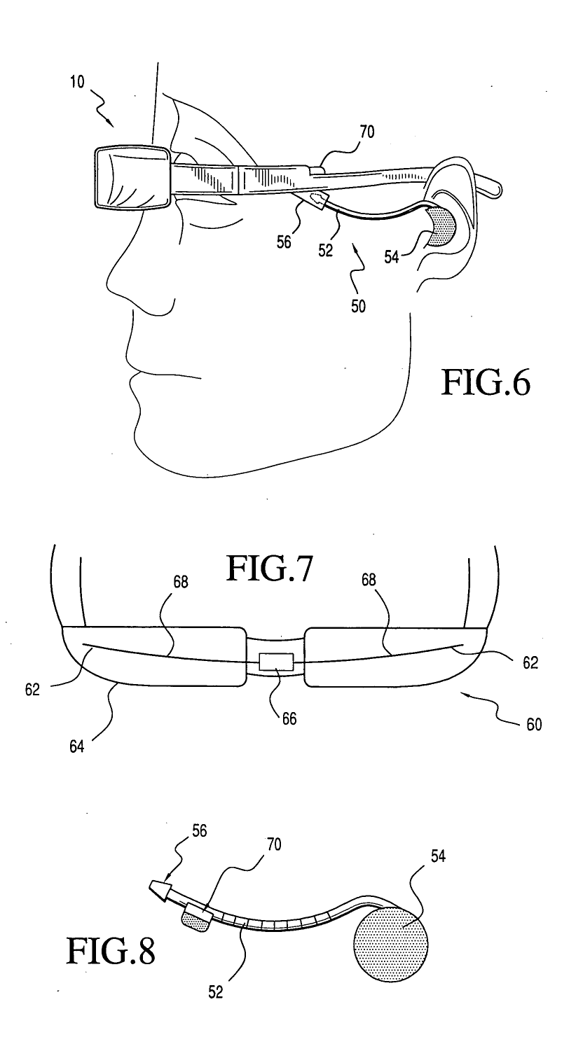

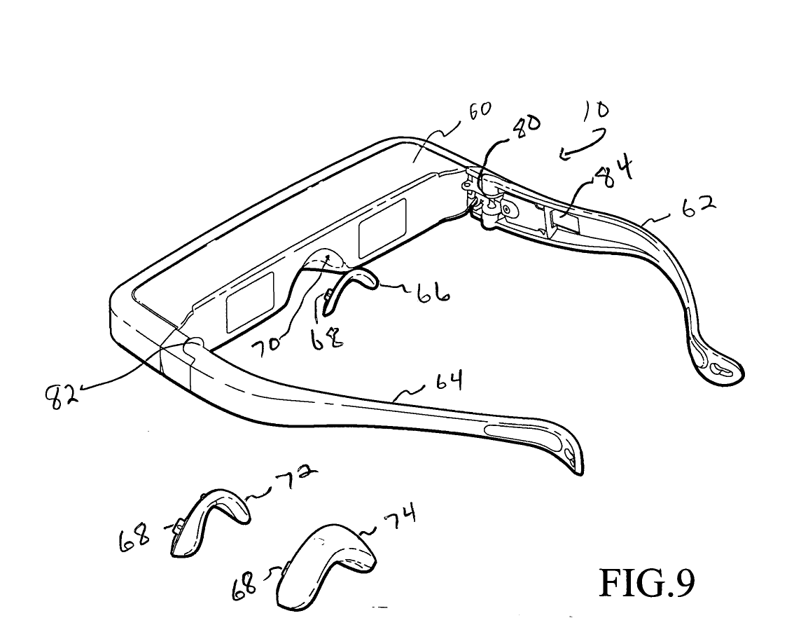

FIG. 7 shows another embodiment of the virtual display IMAGING DEVICE 50 where the connection 52 is in the front frame 54 where there is one image generator or engine as in “bi-ocular” display design that only uses one virtual display engine as discussed in the co-pending application MICRO DISPLAY ENGINE owned by the same assignee.

FIG. 8 shows the speaker 34 on the end of the FLEXPIPE boom 30. One end of the FLEXIPIPE boom is plugged into the jack receptacle and the other end has the speaker 32. The pipe 36 itself can be bent to adjust the position of the speaker to the user's ear. The imaging device could have two audio jacks, one could be for stereo. Optionally, there could be a microphone attached to the same jacks or a separate jack. The microphone could be built into the bow.

Another embodiment of the invention having additional features is shown in FIG. 8. The device indicated generally at 10 includes a binocular frame 60 having right and left temples 62 and 64 for engaging the sides of the head and ears of a wearer for supporting the imaging device 10 with the binocular frame positioned in front of the wearers eyes.

A removable nose piece 66 is provided with an attaching lug 68. Nose piece 66 is received within a complementary shaped cavity on the binocular frame. Lug 68 and the corresponding lug on the opposite side of the nose piece are engaged within receptacle's 70 and the corresponding receptacle on the opposite side of the cavity (not shown). Additional nose piece is 72 and 74 are provided for adapting the device 10 to wearers with different sized facial features.

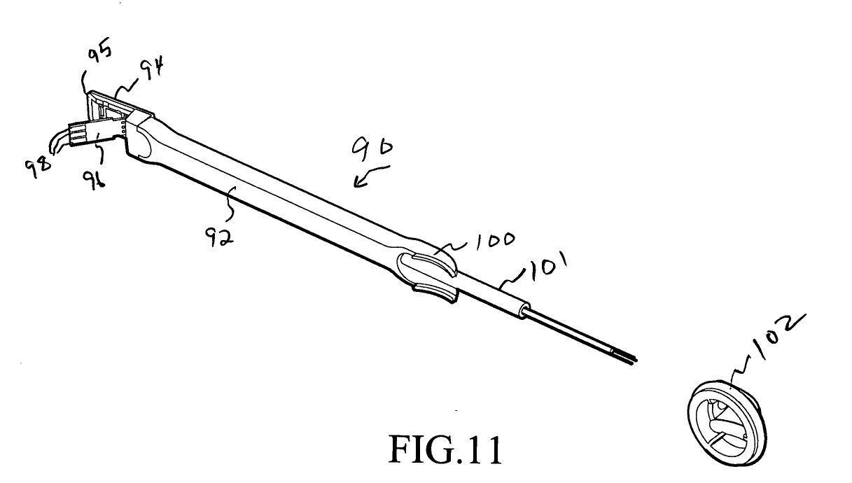

Temple's 62 and 64 are attached to the binocular frame 60 with hinges 80 and 82 as already described. Temple's 62 and 64 are provided with connectors 84 and a corresponding connector on left temple 64 (not shown) for receiving right and left ear buds as shown in FIG. 11.

Referring to FIG. 11, an earbud in accordance with this invention is illustrated in exploded form. The earbud designated generally at 90 includes an elongated deformable body 92 having a connector 94 at one end and a curved earbud holding a portion 100 at the other end. The elongated deformable body 92 may be bent and/or twisted into a desired configuration and will maintain its configuration. This allows the earbud to be positioned with respect to the ear of a user and remain in position during use. The connector 94 includes a generally rectangular extension having a tapered end 95 that is receivable in the socket 84 on the temple of the display. The connector includes an electrical connector board 96 which may be a printed circuit board having terminals 98 on one end thereof. The terminals 98 are adapted to engage similar terminals in the sockets on the left and right temples respectively. The combination of connector 94 and terminals 98 physically and electrically couple the ear buds to the display device.

And electrical cable 101 extends from the connector board 96 through the flexible housing 92 to a speaker 102 mounted in the receiving portion 100. Preferably, earbud assembly 90 is symmetrical so that it can be connected to and used on either temple of the display device. This reduces the overall cost of the device by reducing the amount of tooling required and the number of different parts that must be provided.

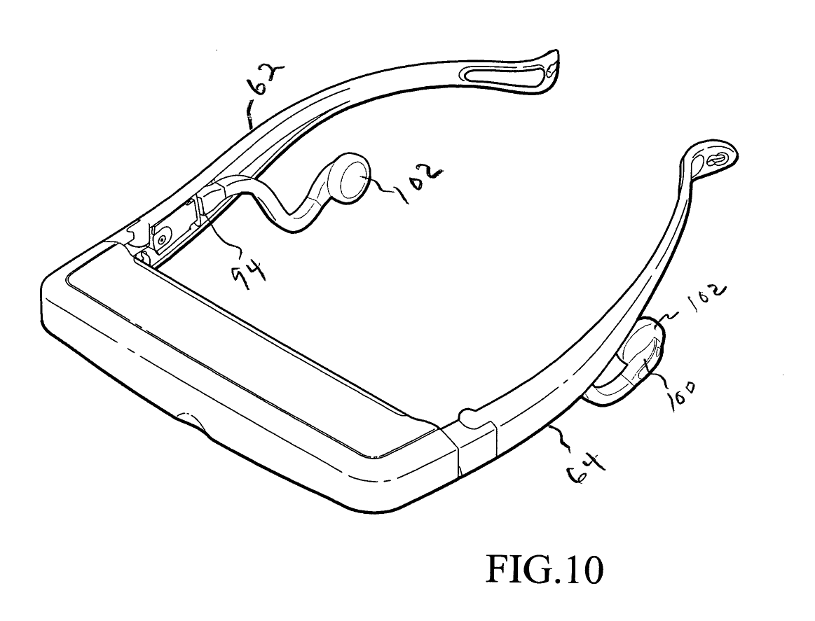

FIG. 10 is a prospective view of the display showing left and right ear buds in place. As can be seen, the body ear buds are configured in a generally reverse S-shaped configuration to position the state is adjacent the left and right ears of the user. The connectors 94 both physically mount the ear buds to temples and provide electrical connections to speakers.

The invention has been described in detail with particular reference to certain preferred embodiments thereof. It will be understood that variations in modifications can be affected within the spirit and scope of the present invention.

1. A binocular display imaging device, comprising:
a frame
first and second optical displays mounted on the frame;
first and second temples pivotally connected to the frame, the frame being pivotable between first and second positions, the first position being aligned with the line of sight of a user whose gaze is directed substantially horizontally, the second position being aligned with the line of sight of a user whose gaze is directed substantially downwardly.

2. The display of claim 1 in which the temples and the frame are arranged so that the frame and the temples may be moved between a first position in which the display is substantially aligned with the line of sight of a user was gaze is directed substantially horizontally, and a second position in which the display is substantially below the line of sight of a user whose gaze is directed substantially horizontally.

3. The display of claim 2 in which when the display is located substantially below the aligned of sight of a user whose gaze is directed substantially horizontally, the frame is pivotable to the second position so that the displays are substantially aligned with the line of sight of the user when the user's gaze is directed downwardly towards the frame.

4. The imaging device of claim 1 further comprising a translational adjustment on the bow to allow the front frame to be moved translationally.

5. The imaging device of claim 1 further comprising a removable, replaceable nose piece.

6. The imaging device of claim 1 further comprising a limit to stop pivotal movements at the first and second positions.

7. The imaging device of claim 1 in which at least one temple comprises a connector for making physical and electrical connection to an earpiece.

8. The imaging device of claim 7 comprising an earpiece physically and electrically connected to the connector.

9. The imaging device of claim 8 in which the earpiece comprises:
a connector making electrical and physical connection to the binocular display device;
a deformable flexible body attached to the connector;
a speaker connected to the deformable flexible body; and
a plurality of electrical conductor's extending from the connector for the flexible body to the speaker.

10. An earpiece for a binocular display device comprising:
a connector making electrical and physical connection to the binocular display device;
a deformable flexible body attached to the connector;
a speaker connected to the deformable flexible body; and
a plurality of electrical conductors extending from the connector through the flexible body to the speaker.

11. The ear piece of claim 10 in which the connector, deformable flexible body and speaker are arranged symmetrically so that said earpiece may be used for the left or right ear of a user.

12. The earpiece of claim 10 in which the connector comprises a printed circuit board having a plurality of electrical contacts formed thereon.
